(19) United States
(12) Patent Application Publication
(10) Pub. No.: US 2006/0235981 A1
(43) Pub. Date: Oct. 19, 2006

(54) Providing a second service to a group of users using a first service

(75) Inventors: Ilkka Westman, Helsinki (FI); Tao Haukka, Oulu (FI); Reijo Nousiainen, Helsinki (FI); Arto Leppisaari, Kangasala (FI); Jari Mutikainen, Lepsama (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/337,488

(22) Filed: Jan. 24, 2006

(30) Foreign Application Priority Data
Apr. 19, 2005 (EP) 05008496.1

(51) Int. Cl. G06F 15/16

(52) U.S. Cl. 709/227

(57) ABSTRACT

The invention relates to providing services to a group of users, wherein the group of users is assigned to a first service, the group being identified by a common group identity, and each of the users assigned to the first service may have different states regarding the first service. The invention proposes methods, network control elements and terminal devices in order to provide a second service with respect to the users of the first service based on their state regarding the first service.

### BACKGROUND OF THE INVENTION:

1. Field of the Invention

The invention relates to a method for providing services to a group of users which are using a first service, wherein to a subgroup of these users a second service is to be established. The invention also relates to a corresponding network control element and a corresponding terminal device.

2. Description of the Related Art

An example for a first service as described above is PoC (push-to-talk over cellular), and an example for a second service as described above is IM (instant messaging).

In detail, PoC is a half-duplex voice over IP service, which is planned to be enhanced by allowing other media (such as text or video) to be used as an alternative or additional communications media between the PoC group participants. PoC text is a new feature candidate for the next release of PoC (PoC 2) in OMA (Open Mobile Alliance) standardisation organisation.

A PoC group can be either a temporarily created (ad-hoc) or a permanent server based group (pre-arranged or chat group). An ad-hoc group is created by the user with a group member list sent to a server. A permanent server based group can be created either by the user or by the service provider. In case of permanent server based groups, the group definition exists in a group server (XDMS (XML Data Management Server), as an example for a network administration server) and contains the group name, unique Group ID (SIP URI), group member list and other necessary group parameters. In case of ad-hoc group there is no group definition on a server. The group member list defines the users that are allowed to join to the group. There may be open groups, e.g., open chat group without a member list meaning that whoever can join to the group. When a PoC group session is created, normally only a part of the group members are able to join the group session. Therefore, during an active group session, the group has two participant lists: all group members (permanent, from group definition (XDMS) or from ad-hoc group member list) and active participants (temporary, and may change during the session).

A PoC user can in current PoC standard solution use only voice for communication with other PoC (group) participants. Text based communication has been proposed as an additional communications media for PoC. Because messaging is already specified in OMA, PoC text messaging may utilise an IM enabler for PoC text messaging. Due to the independence between PoC and IM service enablers, the implementations may be based on two different servers (PoC server, IM server). This would lead to the situation that the services look like two separate services from the end user perspective, because PoC server takes care of voice communications and IM server of text messaging. Moreover the IM server is not aware of the PoC session participants. As a consequence, if a PoC user wishes to send a text message to other active (participating) or inactive (non-participating) group members, he/she has to manually select the recipients (e.g. participating or inactive PoC members). Instead of text or in addition to text the message may contain other media types e.g. video, voice, game data, figures, photos etc.

Another problem is that a PoC user may not be able to send a text message to group member(s) in case of pre-arranged PoC group and Chat group in which member data is (typically) not stored in the terminal, unless the sender is the group host (i.e. the group owner/creator).

Furthermore, OMA (Open Mobile Alliance) PoC specifies a mechanism for sending PoC service messages e.g., Group Advertisement for all group members. But there is no mechanism for sending a message e.g., Group Advertisement or IM to all active (i.e. currently participating) members of a group session.

That is, currently the PoC user has to enter the list of recipients manually if he/she wants to send a text message to the PoC session participants; alternatively the PoC user has to define PoC group and IM group as identical in order to be able to use the text messaging for PoC group members. However, as stated earlier, in this case the IM server knows only the whole group member list but not the currently participating members in a PoC session.

Thus, the simultaneous use of the PoC service and the IM service is unsatisfactory. This problem, however, does not only occur in this specific example, but may occur in connection with a simultaneous use of more than one group communication service. All of these can lead to a bad user experience when requesting a second service such as IM in connection with an already established first service such as PoC.

Another example for services, wherein a group of users uses a first service, wherein to a subgroup of these users a second service is to be established, is conference service and video stream. Namely, the conference service as a first service is established to the group of users, while video stream is established to the subgroup. Also in this case, it is necessary for a user to enter a list of recipients manually to which a video stream is to be sent. Hence, the same problems as described above in connection with PoC and IM also occur.

Furthermore, the above problem may also occur in case more than two services are used.

### SUMMARY OF THE INVENTION

Hence, it is an object of the present invention to solve the problem mentioned above and to improve the user experience when using two or more services in connection with each other.

This object is solved by a method of providing services to a group of users, wherein the group of users is assigned to a first service, the group being identified by a group identity, each of the users assigned to the first service may have different states regarding the first service, the method comprising the steps of receiving a request for a second service to users assigned to the first service, said request comprising the group identity and an indication of the state regarding the first service, providing the second service to the users having the indicated state in the first service.

Furthermore, the object is solved by a network control element, the network element being part of a system where a group of users is assigned to a first service, the group being identified by a group identity, and each of the users assigned to the first service may have different states regarding the first service, the network control element comprising means for receiving a request for providing a second service to users of the group, the request comprising an identity of the group and an indication of the state of the users regarding the first service; means for discovering members of the group; means for discovering the states of the members regarding the first service; and means for processing the request for providing the second service to the members of the group, the discovered state thereof is matching the indication of the state.

Alternatively, the object is solved by a terminal device configured to be used for a first service, to which a group of users is assigned, the group being identified by a group identity, each of the users assigned to the first service may have different states regarding the first service, the terminal device comprising a first requesting means for requesting the users assigned to the group identity, and requesting information on the users of the group currently participating in the first service, determining means for determining states of the users of the group regarding the first service based on the requested information, and a second requesting means for requesting a second service for the users selected depending on the state of the users regarding the first service.

Alternatively, the object is solved by a method of providing services to a group of users, wherein the group of users is assigned to a first service, the group being identified by a group identity, each of the users assigned to the first service may be active or inactive with respect to the first service, wherein a session identity is assigned to the users being active in the first service, the method comprising the steps of receiving a request for establishing a second service to users assigned to the first service based on the session identity, and providing the second service to the users being active with respect to the first service.

As a further alternative, the object is solved by a terminal device configured to be used for a first service, to which a group of users is assigned, the group being identified by a group identity, each of the users assigned to the first service may be active or inactive with respect to the first service, and a session identity is assigned to the users being active in the first service, the terminal device comprising a requesting means for creating a request for a second service, wherein, when the second service is to be established to active users assigned to the first service, the request is created based on the session identity, and a sending means for sending the request for the second service to a network control element hosting at least one of the first and the second service.

In addition, the above object is also solved by a network control element for hosting a first service for a group of users, wherein the group of users is assigned to the first service, the group being identified by a group identity, each of the users assigned to the first service may be active or inactive with respect to the first service, and a session identity is assigned to the users being active in the first service, the network control element comprising a receiving means for receiving a request for establishing a second service to users assigned to the first service based on the session identity, and a service providing means for providing the second service to the users being active with respect to the first service.

As a further alternative, the above object is solved by a terminal device configured to be used for a first service, to which a group of users is assigned, the group being identified by a group identity, the terminal device comprising: detecting means for detecting that a second service is to be requested to users assigned to the first service having a predetermined state regarding the first service; requesting means for creating a request for providing the second service, wherein the request comprises the group identity of the first service and an indication of said predetermined state regarding the first service, and sending the request to a server providing at least one of the first and the second service.

In detail, according to the present invention several ways are provided to request or establish a second service with respect to a subgroup of a user group assigned to a first service based on the state of the corresponding users.

Thus, a user is enabled to easily request or establish a second service to the corresponding subgroup.

It is noted that the invention is not limited to only two services, but a plurality of services may be used.

Further advantageous developments are set out in the dependent claims.

### BRIEF DESCRIPTION OF THE DRAWINGS

The invention is described by referring to the enclosed drawings, in which:

FIG. 1 illustrates a PoC client, a PoC server hosting a PoC service, an IM server hosting an IM service, a group list server and a plurality of users of the PoC service according to the first to fourth embodiments,

FIG. 2 shows a signalling flow for a server based solution according to the first embodiment,

FIG. 3 shows a signalling flow for a server based solution according to the second embodiment,

FIG. 4 shows a signalling flow for a server based solution according to the third embodiment,

FIG. 5 shows a signalling flow for a server based solution according to the fourth embodiment,

FIG. 6A shows a combined PoC/IM server as applicable to the first to third embodiments, and FIG. 6B shows an IM server as applicable to the fourth embodiment,

FIG. 7 shows a signalling flow in case of separate PoC and IM servers,

FIG. 8 shows a signalling flow for a client-based solution according to a fifth embodiment,

FIG. 9 shows a user equipment (UE) and a PoC server according to the fifth embodiment,

FIG. 10 shows a signalling flow according to a sixth embodiment, and

FIG. 11 shows a user equipment (UE) and a PoC server according to the sixth embodiment.

### DETAILED DESCRIPTION OF THE PREFERRED EMBODIMENTS

In the following, preferred embodiments of the present invention are described by referring to the attached drawings.

According to embodiments of the invention, the situation is handled in which two or more services are used simultaneously in connection with one group. In particular, a second (third, fourth etc.) service may be established or requested in connection with only a subgroup of a group of users, which are assigned to a first service. In the first service, each of the users may have different states, and the subgroup is identified based on the state of the users with respect to the first service. Hence, the second (third, fourth etc.) service is established to the group of users based on their state, i.e., only to a subgroup of users which all have the same state.

In this connection “assigned to the first service” means that the users belong to a group for the first service, the group having a unique identity. However, the users may have different states in the group, i.e., may be active or inactive or the like.

In the following description of embodiments, a PoC (Push-to Talk over Cellular) Service is taken as an example for the first service, and an IM (Instant Messaging) Service is taken as an example for the second service. It is noted that in PoC the users of a PoC group may have two different states: either they participate in a current PoC session (i.e., are active, that is, are participants) or they do not (i.e., are inactive, that is, are non-participants).

That is, according to the embodiments, IM messages may be sent to subgroups of the corresponding PoC user group, e.g., to inactive members.

The PoC group is identified by a group identity, which may be a group address or group URI (Universal Resource Identifier). In the following embodiments, “group-776@oper.net” is used as an example group identity.

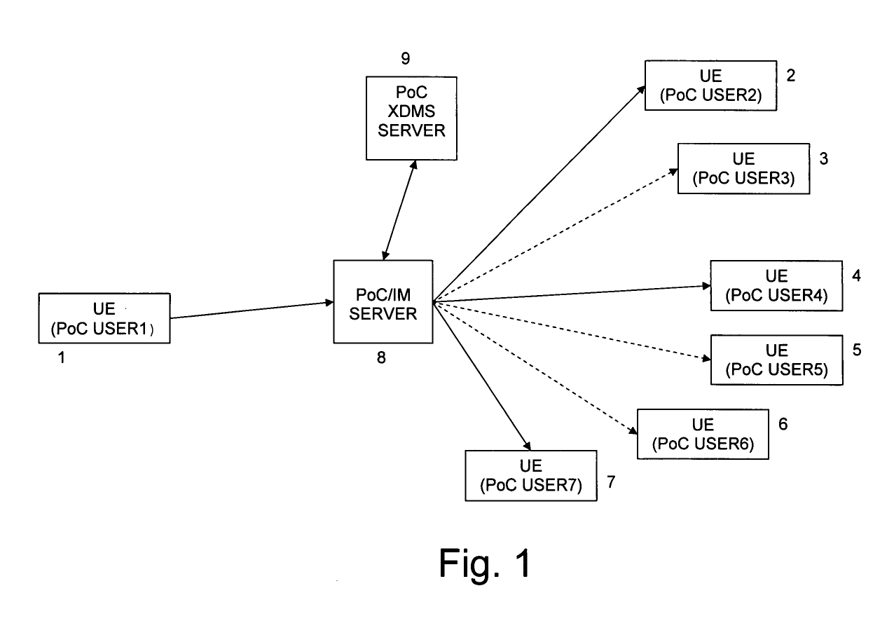

According to a first embodiment, a server-based solution is adopted. The basic structure of the network elements involved is shown in FIG. 1. Reference numerals 1 to 7 denote user equipments (UE) of members (i.e., user1 to user7) of a PoC group, respectively. In the following, it is assumed that user1 attempts a PoC connection to the PoC group. Furthermore, it is assumed that user3, user5 and user6 are active, i.e., participate in the actual PoC session, whereas user2, user4 and user7 are inactive, i.e., the UEs 2, 4 and 7 might not be set to the PoC mode or may be switched off or may have not accepted the invitation to participate in the group session.

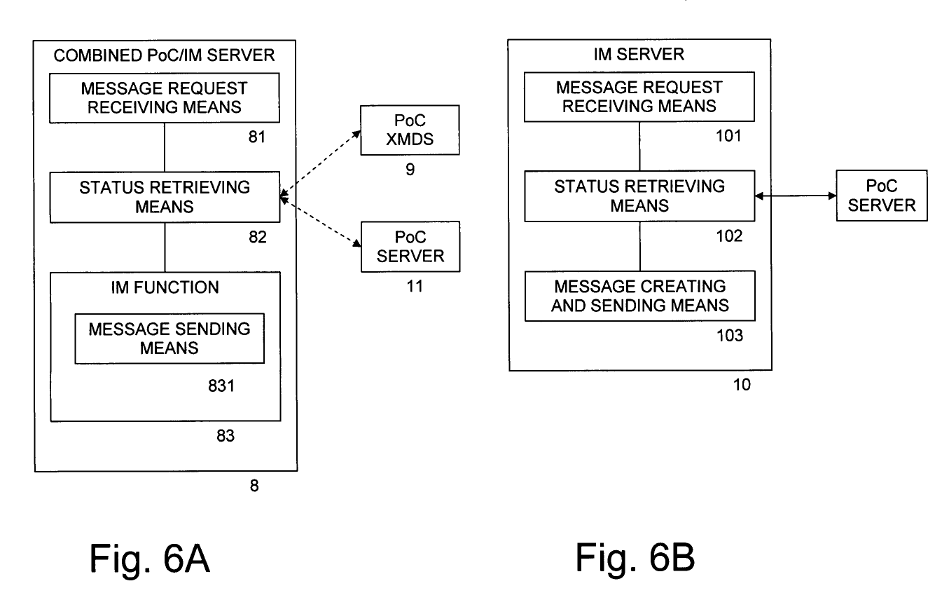

Reference numeral 8 denotes a combined PoC/IM server which hosts the PoC service and the IM service. It is noted that the invention is not limited to a combined PoC/IM server, but also two separate elements are possible, as will be described later. The details of the PoC/IM server are described later in connection with FIG. 6A.

Reference numeral 9 denotes a PoC XDMS (XML Data Management Server) as an example for an administration server, which may store a member list of the PoC group, for example.

According to the first embodiment, user1 has an ongoing PoC session with user3, user5 and user6, as mentioned above, as also indicated by the dashed arrows in FIG. 1. Thus, one of the participating members, e.g., user1 would like to contact the other (i.e., the inactive members user2, user4 and user7) via IM, as indicated by the solid arrows in FIG. 1.

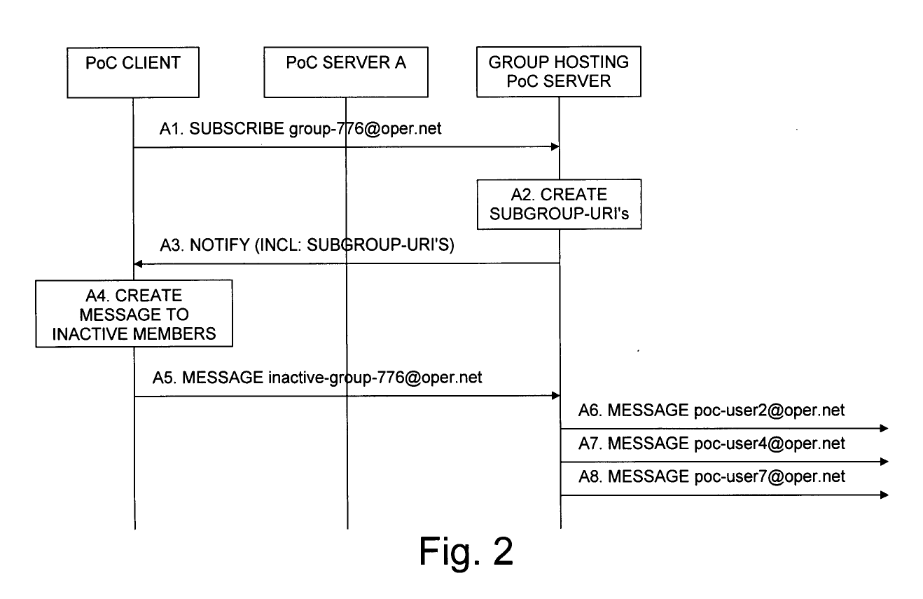

The signalling flow according to the first embodiment is shown in FIG. 2. It is noted that only the essential signalling is shown in FIG. 2 (this applies also for all figures of the present application). Nevertheless, in FIG. 2 a PoC server A (home PoC server of user1) is shown. The whole or a part of the signalling between the PoC client of user1 can be routed via this PoC server A.

According to the first embodiment, the PoC Server hosting/owning the PoC Group keeps three lists up-to-date all the time: the list of members of the PoC Group, e.g. whole-group-776@oper.net, the list of the participants in the corresponding PoC Group Session, e.g., active-group-776@oper.net, and the list of those not participating in the corresponding PoC Group Session e.g. inactive-group-776@oper.net. The first list whole-group-776@oper.net may be the same as group-776@oper.net.

The PoC client may ask these URIs by sending a SUBSCRIBE to the PoC server hosting or owning the group in question in step A1. In step A2, the group hosting PoC server (8 in FIG. 1) creates an URI whole-group-776@oper.net for the list of all members of the PoC Group, and an URI active-group-776@oper.net for the list of those members participating in the corresponding PoC Group Session, and an URI inactive-group-776@oper.net for the list of those members not participating in the corresponding PoC Group Session. In step A3, these URIs are included in the response and sent to the PoC client of user1. This response may be a NOTIFY message, for example.

In step A4, the PoC client may utilize the URIs when, for example, sending a MESSAGE request to those members of the group not participating in the actual PoC Group Session. In step A5, such a MESSAGE is sent to the group hosting PoC Server. Since the message is directed to the inactive members, the address is inactive-group-776@oper.net. Since the group hosting PoC Server is a combined PoC/IM server, it can now function as an IM server and send the messages to each user of the list of the inactive group members. That is, in the present case, in step A6 the message is sent to user2 (i.e., MESSAGE to poc-user2@oper.net), to user4 (i.e., MESSAGE to poc-user4@oper.net) and to user7 (i.e., MESSAGE to poc-user7@oper.net).

Analogically one of the inactive members (e.g. user4) may send a message to active, inactive or all members of the group.

It is noted that according to the first embodiment, the lists are differentiated with a prefix as an indication of the type of the URI. The prefixes used here are only examples. Alternatively the indication of the type of the URI may be carried in a suffix, in a character or a bit string, in a new or an existing header of the request, in the body of the request, as a parameter or a like. For example, the domain part may be modified: e.g., group-776@active-group.oper.net, or a separate parameter may be used: group-776@oper.net; active, or a new header called “Subgroup-Type” with values e.g. “active”, “inactive” or “all” may be used to indicate the type of the URI e.g.

INVITE group-776@oper.net

Subgroup-Type: inactive

According to the embodiment described above, the PoC Client asks the URIs e.g. by sending a SUBSCRIBE request and receiving a corresponding NOTIFY response. However, also other suitable request/response pairs may be used, for example MESSAGE or OPTIONS followed by 200 OK response or a 300 Multiple Choices response or the like. That is, the PoC Server may send the mentioned URIs in the response e.g. in the body or header(s) of the 200 OK, 300 Multiple Choices, or other 3xx response or other response to MESSAGE or in NOTIFY to SUBSCRIBE or in any other response. Also other protocols may be used instead of SIP e.g. XCAP (extensible Markup Language (XML) Configuration Access Protocol), XCON (Centralized Conferencing), CPCP (Conference Policy Control Protocol), XML (extensible Markup Language), HTTP (Hyper Text Transfer Protocol) etc. Also more than one protocol may be used together, co-operating, combined or other way. There may still be other ways to get the list URIs from the PoC server to the PoC Client.

Moreover, in case the group hosting PoC server does not have the actual group list, it can retrieve the member list of the PoC Group from a Group Administration server e.g. PoC XDMS (reference numeral 9 in FIG. 1), for example. The corresponding signalling could be effected by XCAP (XML Control Access Protocol) or by SUBSCRIBER/NOTIFY, for example.

Moreover, as indicated above, the signalling between the group hosting PoC server and the PoC client can be routed via the home PoC server (PoC server A) of the PoC client. That is, in step A1, the SUBSCRIBE message is firstly sent to the PoC server A, which forwards it to the group hosting PoC server. The response, i.e., the NOTIFY message in step A3 may be sent firstly to the PoC Server A, which forwards it to the client. Moreover, also the MESSAGE request in step A5 may firstly be forwarded to the PoC server A.

Thus, according to the first embodiment an easy handling of sending of IM messages to a subgroup of a PoC group is possible. Since only the URIs of the corresponding subgroups are sent to the PoC client, radio resources are saved.

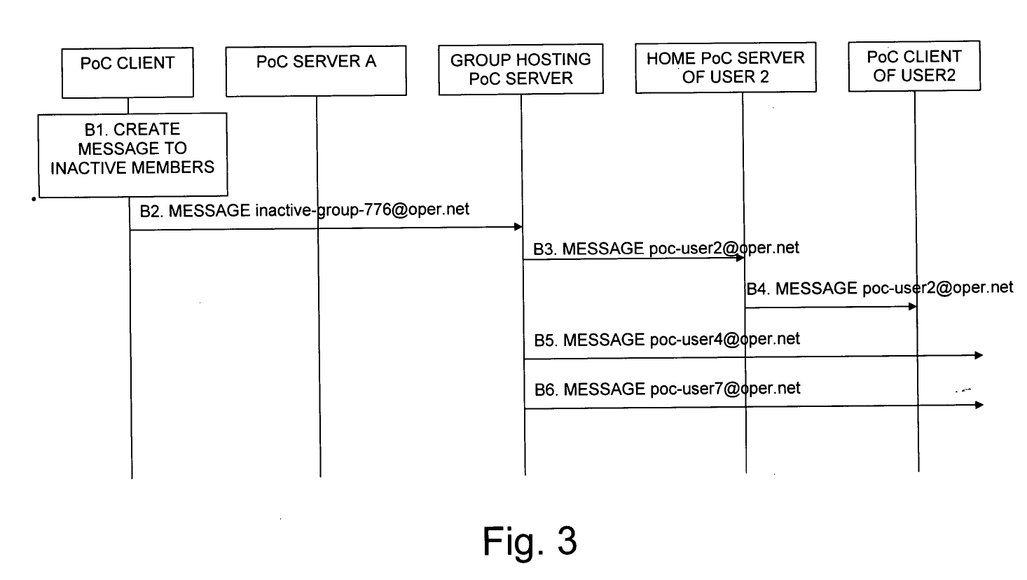

In the following, a second embodiment is described. The second embodiment is similar to the first embodiment, so that in the following only the differences from the first embodiment are described by referring to the signalling flow diagram shown in FIG. 3. Hence, also the second embodiment describes a server-based solution.

According to the second embodiment, the URIs of the lists need not to be conveyed to the PoC Client, because they are known to the PoC Clients by other means, for example, being standardised. That is, in case the group address is known (e.g. group-776@oper.net), it is clear how the subgroup addresses are to be formed: For example, when using prefixes as in the first embodiment, the address of the inactive members is formed by “inactive-” plus group address, the address of the active members is formed by “active-” plus group address, and the address of all members is formed by “whole-” plus group address. In similar way, corresponding rules could be determined for suffixes, parameters and the like. In particular, certain parameters (such as “active”, “inactive” and the like) could be defined. In one embodiment, a new URI parameter, such as “my_group@oper.net; active” is standardised or introduced. Alternatively, a new header, e.g. P-header may be introduced. When using this kind of fixed syntax, additional URIs need not be routable to the server.

The corresponding signalling flow/steps are shown in FIG. 3. In step B1, the PoC client of a member, e.g., user1 creates a message to, e.g., the inactive members of the group, wherein the address is formed as described above. In step B2, a MESSAGE request is sent to the group hosting PoC server (i.e., the PoC server hosting the group group-776@oper.net). As described in the first embodiment, the request may be routed via the PoC server A. Similar as in the first embodiment, the group hosting PoC server is a combined PoC/IM server. Thus, in step B3, B5 and B6 the IM function of the group hosting PoC server sends MESSAGE request to the inactive members of the group (i.e., user2, user4 and user7).

Thus, according to the second embodiment the radio resources are saved even more with respect to the first embodiment, since it is not necessary to send the URIs of the subgroups to the PoC client.

Similarly, as in the first embodiment, these MESSAGE requests may be sent directly from the group hosting PoC server or may be routed via the corresponding home PoC servers of the users. With respect to user2, this is shown in more detail: namely, in step B3, the MESSAGE request is firstly sent to the home PoC server of user2, and in step B4, the MESSAGE request is finally sent to the PoC client of user2, i.e., to his UE.

Furthermore, the modifications of the first embodiment may also be applied to the second embodiment. In particular, the group hosting PoC server may retrieve the list of the PoC group members also from an administration server.

In the following, a third embodiment is described. This embodiment is similar to the second embodiment, so that basically only the differences to the second embodiment are described. Hence, also the third embodiment describes a server-based solution.

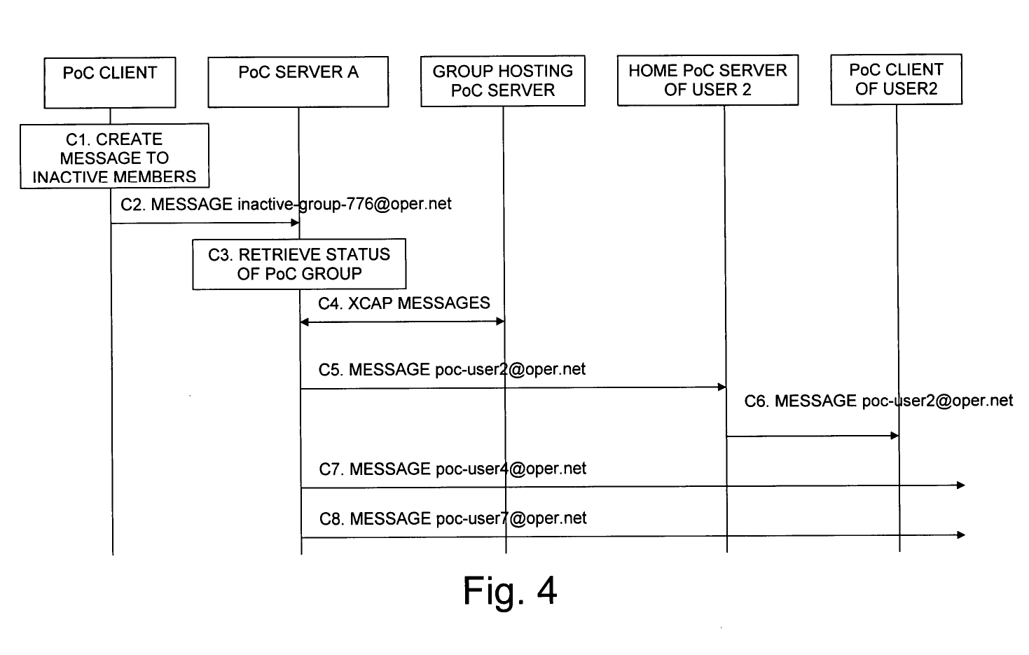

In detail, according to the third embodiment, after creating the message to the subgroup (e.g., the inactive members) in step Cl, the PoC Client of a member, e.g., user1 sends the request to its POC server A (home PoC Server) in step C2. The PoC server A retrieves the status of the PoC Group from the PoC Server hosting/owning the PoC Group in step C3. In detail, in FIG. 4 this is effected by using suitable XCAP messages and XML in step C4, but alternatively HTTP or SUBSCRIBE/NOTIFY or other suitable request/response messages may be used. Also other protocols and other means may be used.

According to the present embodiment, the complete group status is retrieved, that is, all members for the group and their current states (active/inactive/whole). Alternatively, only the list of users having a specified state may be retrieved.

Thereafter, the PoC Server A sends the request further to each recipient having a requested state in steps C5, C7 and C8. That is, the home PoC Server sends the original request received from the PoC Client to each PoC User having a state “inactive” in the group session. In this example, the routing of the request to user2 via his home PoC server is illustrated in steps C5 and C6.

Thus, the procedure of the third embodiment can easily be implemented since a single SIP (Session Initiation Protocol) dialog can be re-used.

It is noted that according to the third embodiment the PoC server A (home PoC server) is a combined PoC/IM server, so that the group hosting PoC server may be a dedicated PoC server without an IM function.

Furthermore, similar to the first and second embodiment, the home PoC server or the group hosting PoC server may retrieve the group member list from an administration server (such as a PoC XDMS), in case the group member list is not available at the group hosting PoC server, for example.

An example for a combined PoC/IM server as used according to the first, second and third embodiments is illustrated in FIG. 6A. As shown, the combined PoC/IM server 8 (see also FIG. 1) comprises a message request receiving means 81, which receives the MESSAGE request, i.e., a request for the second service (IM). Furthermore, the PoC/IM server comprises a status retrieving means 82 for detecting the actual status of the users by looking up the state of the users in the current PoC session. This may be effected by accessing the group hosting/owning PoC server (denoted by reference numeral 16 in FIG. 6A), as described in connection with the third embodiment. The status retrieving means 82 may detect also the member list of the group. As an alternative or in addition thereto, the above may also be effected by accessing a network administration element such as a PoC XDMS 9, as described above. Furthermore, the PoC/IM server comprises an IM function unit 83, which includes a message sending means 831 for sending messages to the users.

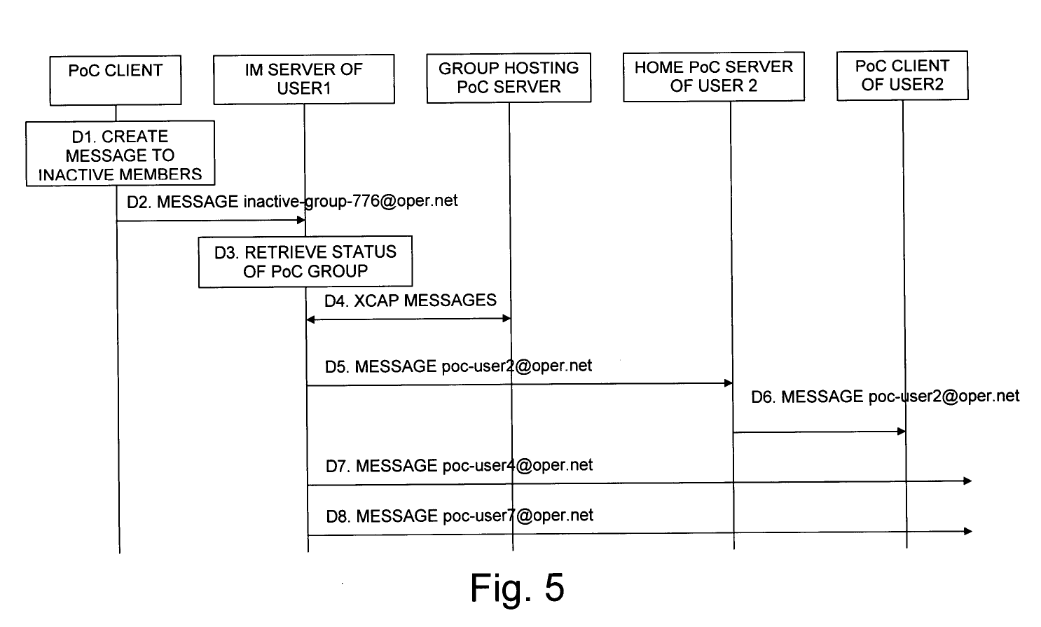

In the following, a fourth embodiment is described by referring to FIG. 5. This embodiment is similar to the third embodiment, so that in the following basically only the differences to the third embodiment are described.

In detail, according to the present embodiment an IM server is used instead of the home PoC server. That is, for the home PoC server no combined PoC/IM server is used, but a modified IM server is applied. This modified IM server according to the present embodiment is adapted to retrieve the URI lists in response to receiving the MESSAGE request directed to the subgroup (e.g., inactive members) of the group in question. That is, the IM server is configured to retrieve the necessary information (i.e., the URI list or only the URI for the subgroup in question, such as the inactive members) from the group hosting PoC server.

The steps D1 to D8 otherwise correspond to the steps C1 to C8 described in connection with FIG. 5.

The modified IM server according to the fourth embodiment is illustrated in FIG. 6B. The IM server, denoted by reference numeral 10, comprises a message request receiving means 101, which receives the MESSAGE request, i.e., the request for the second service (IM). Furthermore, the IM server comprises a status retrieving means 102 for detecting the actual status of the users by looking up the state of the users in the current PoC session. This is effected by accessing the PoC server, as described above. Furthermore, the IM server comprises a message creating and sending means 103, which creates the messages for the users and sends them.

Hence, also the procedure according to the fourth embodiment can easily be implemented since it is standard compliant. Namely, the user equipment may send the IM MESSAGE request to the IM server, so that only modifications to the IM server are necessary.

Thus, according to the server based solutions according to the first to fourth embodiments, the IM is addressed using the group identity, but the IM may contain an additional parameter indicating that the user wishes to send the IM only to a subset of the group (such as only active or inactive members). The PoC/IM server then discovers the actual group members and their current status (a group list server such as XDMS may be contacted) and forwards the IM only to the requested recipients (e.g., status=active).

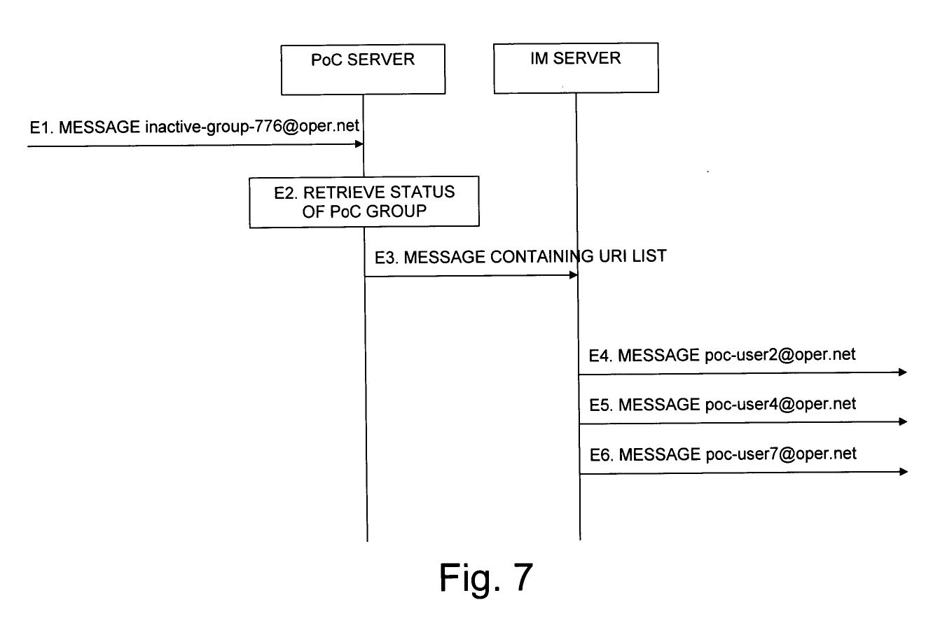

FIG. 7 shows another example, where two separate network elements are used instead of a combined PoC/IM server. The PoC server and the IM server shown in FIG. 7 may be used instead of the group hosting PoC server shown in FIGS. 2 and 3, or instead of the home PoC server as shown in FIG. 4.

In particular, upon receiving a message addressed to the subgroup (in this example, to inactive members) in step E1, the PoC server retrieves the status of the PoC group, i.e., prepares a list of the individual URIs of those members belonging to the particular subgroup (inactive members). In step E3, the PoC server forwards a MESSAGE request including the list of the URIs of the subgroup members to the IM server, which in turn forwards the MESSAGE request to all subgroup members. In this way, no modifications to the IM server are necessary.

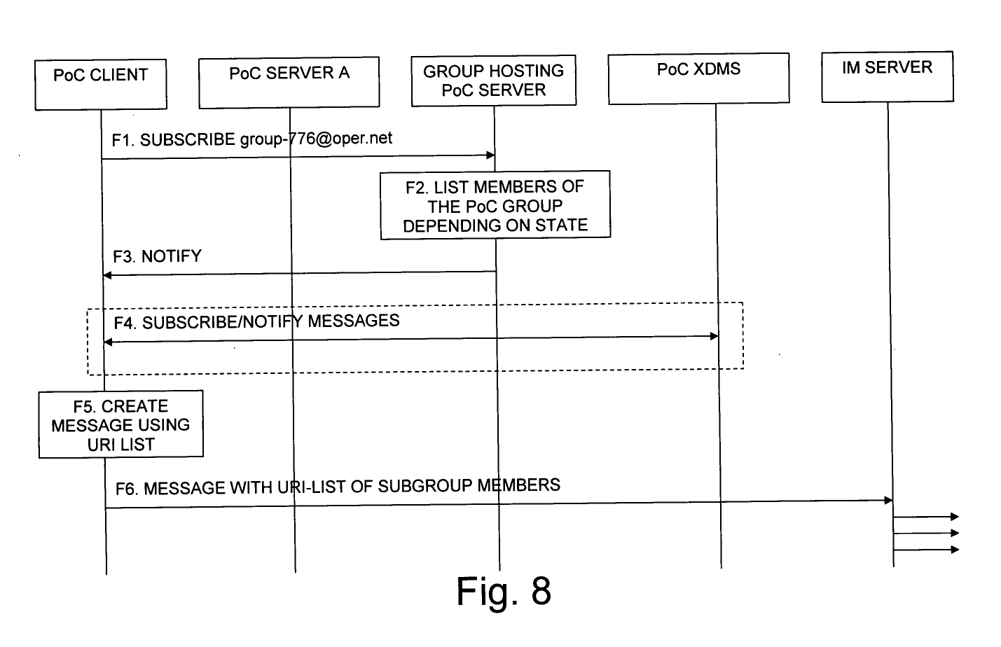

In the following, a fifth embodiment of the invention is described with respect to FIG. 8, in which a PoC client based solution is shown.

According to the fifth embodiment, up-to-date information is provided to the PoC Client of the members and participants of the PoC Group and PoC Group Session. The PoC Client is responsible for storing the information for later use.

This is effected as follows, as shown in FIG. 8: In step F1, the PoC client of the user, who would like to send a message to a part of the PoC group sends a SUBSCRIBE request to the PoC Server hosting/owning the PoC Group. The SUBSCRIBE request is made with an event referring to the Conference State Event Package (as an example for conference related information), for example. However, currently the conference state event package only covers the active members of an on-going session (such as a PoC session). Depending, for example, on implementation it may also cover those members who have been active but are not active anymore i.e. have participated in the on-going session but have left the session. Thus, if the inactive members or all members (depending on their state) should be indicated, the Conference State Event Package has to be correspondingly amended, or a new package has to be defined. Examples for corresponding amendments to the Conference State Event Package are described later by referring to a seventh embodiment.

This is effected in step F2. The list (or lists in case of a plurality of subgroups depending on the different states) is included in a NOTIFY message, which is sent in step F3 to the UE, i.e., the PoC client.

As a further alternative, the list can also be retrieved from the Group Administration Server, e.g., from the PoC XDMS. This is indicated in step F4. For example, the PoC client may send a SUBSCRIBE request to the PoC XDMS, and from the corresponding NOTIFY a user could obtain the necessary list(s) of the members including their states in the session (active/inactive). Other requests, e.g. MESSAGE may be used. Alternatively, instead of SIP also other protocols may be used, e.g. XCAP, XCON, CPCP, XML, HTTP etc. That is, for the SUBSCRIBE/NOTIFY messages shown in step F4, also, e.g., XCAP messages or HTTP messages may be used. Also more than one protocols may be used together, co-operating, combined or other way. There may still be other ways to get the list URIs to the PoC Client.

After this, the PoC Client could send a text message(s) directly to other PoC users (active/inactive) or to an IM server. In the latter case the MESSAGE request contains a list of URIs and the IM server acts as an exploder server and sends similar MESSAGE request to each URI in the URI list. That is, as shown in FIG. 8, in step F5, the PoC client creates a MESSAGE request including the URI list containing, e.g., all inactive members. In step F6, this message is sent to the IM server, which explodes the message to each URI of the URI list.

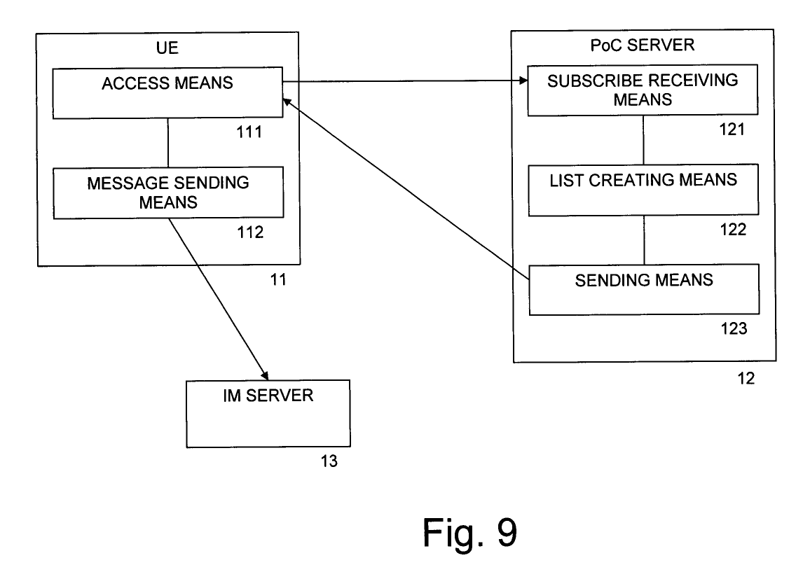

The terminal device, i.e., the user equipment comprising the PoC client, and the PoC server hosting the group according to the fifth embodiment are described in the following by referring to FIG. 9.

The user equipment 11 comprises an access means 111 for accessing the PoC server in order to obtain the list of the users of the PoC group and a message sending means 112 for sending the MESSAGE request (step F6) to the IM server 13 or to other users. The PoC server 12 comprises a subscribe receiving means 121 for receiving the SUBSCRIBE request in step F1, a list creating means 122 for creating the list of the users of the PoC group (depending on the state), and a sending means 123 for sending the NOTIFY message (step F3) to the user equipment.

It is noted that the IM server shown in FIGS. 8 and 9 may alternatively be a PoC server that offers the exploder service, i.e., may be a combined PoC/IM server.

Thus, according to the fifth embodiment an easy handling of IM to a subset of a PoC group is possible, since the necessary URIs of the members of the subgroup can easily be obtained by sending a SUBSCRIBE request or the like. Hence, nearly no change to the current PoC server is necessary.

That is, enhanced Participant Information data is introduced and utilised in the PoC client to make the PoC and IM services' usage as user-friendly and seamless as possible to the end-user. This is done by defining a new information element (group member list) to be included in the current PoC Participant Information message (which may be, for example, a modified Conference State Event Package) and utilise that in the PoC/IM client. Instead that the current Participant Information will be enhanced, the PoC client may retrieve the group member list from group administration server e.g. PoC XDMS. The client can use the enhanced Participant Information data or the information from the group administration server to derive the inactive member list. This would allow e.g. text messages to be sent to the absent group members as a reminder of the ongoing PoC session or to inform them of the next session agenda and schedule. Furthermore, according to the present embodiment an easy way is enabled for the inactive (non-participating) group member to send (a group) text message(s) to the active PoC session participants.

It is noted that the group member list is utilized when building an inactive member list by dropping the active members from the member list. The PoC Server hosting/owning the group typically has means to retrieve the member list from the Group Administration server e.g. PoC XDMS. Other PoC servers, IM server and the PoC Client doesn't typically need the group member list. They may use the same mechanisms (e.g. SUBSCRIBE requests) as the PoC server hosting/owning the group to retrieve the group member list. Or they may retrieve the information from the group hosting/owning PoC server. Or alternatively Participant Information may be enhanced to contain also group member list. Or the group member list is retrieved with other means. Hence, there are various ways to retrieve the group member list.

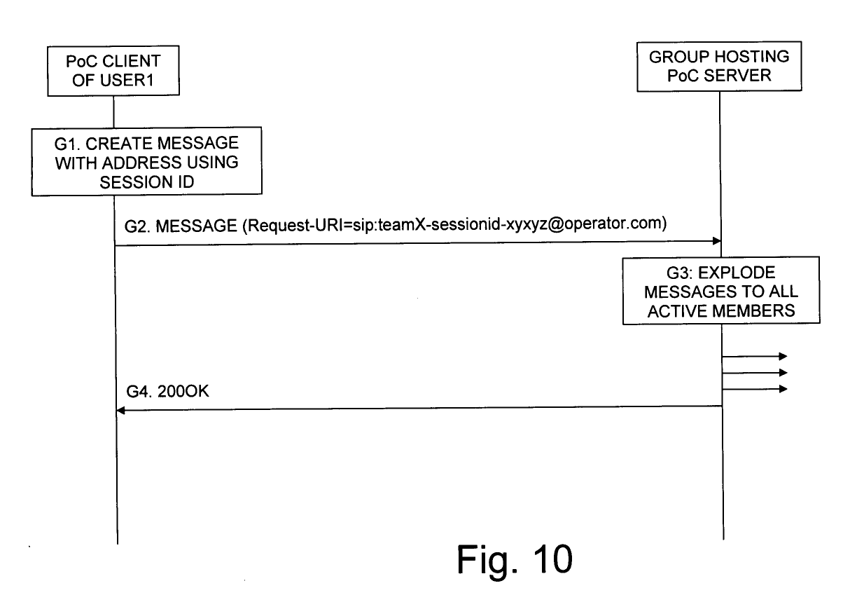

In the following, a sixth embodiment is described by referring to FIG. 10. According to the sixth embodiment a procedure is applied by which a second service such as IM or the like can be established to the active members of a PoC group.

According to the sixth embodiment, the active members of the PoC group (as an example for a user group of a first service) are identified by a session identity, which is used to identify an active session. Thus, an IM message (as an example for a second service) is sent to the session identity, so that only the active members of the group receive the IM message.

In detail, this embodiment uses a Temporary Session Identity mechanism introduced in OMA PoC 1.0. A Temporary Session Identity is also referred to as PoC session identity. The PoC session is identified with a SIP URI, i.e., a routable address. A group (e.g., PoC group) is addressed by the unique Group URI (SIP URI) which is a permanent group identifier and valid as long as the group exists. If a group session is not yet active, a user can send group session establishment request using the Group URI as Request-URI. The server allocates a Temporary Session ID in the group session establishment and the Session ID is given to all participating terminals. It is used, e.g., in case that user has dropped off from session and wants to rejoin. The Session ID is a SIP URI and valid only as long as the particular group session is active. Since the Session ID refers to an active group session and not to the group, it can be used to address only active group members. This embodiment utilises Session ID and introduces a mechanism for sending a message to all active group participants.

In the Following, Three Cases are Described:

1. Sending a Message to All Group Members

It is assumed that a member of the group, e.g., user1 wants to send a message to all members of a group TeamX. Group URI=sip:teamX@operator.com. In this case, it does not matter if there is an active group session ongoing and whether the user is participating a session or not. Procedure is the same in all cases if message is addressed to all group members.

Thus, the user constructs a message and sends it to group URI:

MESSAGE (Request-URI=sip:teamX@operator.com)

The PoC server fetches the group member list from group server XDMS (if necessary) and explodes the message to all group members. This is similar, for example, to steps C4 to C8 shown in FIG. 4 in the case that the whole group is addressed.

After this, the sender of the message gets a 200 OK or 202 Accepted reply to confirm that the server has received the message and exploded or will explode it to group members.

2. Sending a Message to All Active Group Members (Embodiment)

It is assumed that a member of the group, e.g., user1 is participating in a TeamX group session and wants to send a message to all active members of the group session.
Group URI=sip:teamX@operator.com.

The user constructs a message (step G1 in FIG. 10) and sends it to group Session id (step G2). The user equipment (terminal) of the user has received the Session ID, when he joined the current group session. Since User A does not need to know the Session ID, it might be any string (compliant with SIP URI definition) or derived from group URI. Namely, the Session ID is used only for signalling purposes, and user1 should not know that the Session ID even exists. Therefore, the Session ID does not need to be human readable, but can be anything as long as it is compliant with the SIP URI definition.
MESSAGE (Request-URI=sip:teamX-sessionid-xyxyz@operator.com).

Since there is an active group session, the controlling server (which allocated the Session ID, i.e., the PoC server) knows the active group participants. Thus, the POC server explodes message to all active group members. This is similar to, for example, steps C5 to C8 in FIG. 4, wherein the messages are directed to the active members of the group.

The sender of the message gets a 200 OK (step G4) to confirm that server has received the message and exploded it to active group members. Alternatively, in step G4 a 202 Accepted reply may be sent to the sender to confirm that the sender has received the message and will explode it to the active group members.

If user1 is not participating the session, but still wants to send message to all active group session participants, the following applies. The user subscribes to the group session status, i.e., the conference event package using Group URI (using a SUBSCRIBE request). The status notification (received via a NOTIFY message) contains the Session ID. Then, the user may send a message using Session ID in the way as described above.

3. Sending a Message to All Inactive Group Members (Embodiment)

It is assumed that a member of the group e.g. user1 is participating in a TeamX group session and wants to send a message to all inactive members of the group session.
Group URI=sip:teamX@operator.com.

The user constructs a message (like in step G1 in FIG. 10) and sends it to group Session id (like in step G2). The user equipment (terminal) of the user has received the Session ID, when he joined the current group session. To indicate that the message is targeted to inactive members of the group, indication of the type of the URI is used as clarified in the first (and other) embodiment(s). Only those indications cannot be used that modify the URI itself i.e. those that modify the name or the host part of the URI of the group Session identity are not allowed because if modified the group session identity is not the same anymore and the correct group session cannot be found. In this example parameter “inactive” is used to indicate the type of the URI.
MESSAGE (Request-URI=sip:teamX-sessionid-xyxyz@operator.com;inactive).

Since there is an active group session, the controlling server (which allocated the Session ID, i.e., the PoC server) knows the active group participants. The controlling server knows also the members of the group (e.g. by means explained in the previous embodiments). Thus, the POC server is able to deduce those group members that are inactive and explode message to all inactive group members. This is similar to, for example, steps C5 to C8 in FIG. 4, wherein the messages are directed to the inactive members of the group by using parameter “inactive” (instead of the prefix “inactive-” in the URI like used in the FIG. 4).

The sender of the message gets 200 OK or 202 Accepted reply (like in step G4 shown in FIG. 10) to confirm that server has received the message and exploded or will explode it to inactive group members.

If user1 is not participating the session, but still wants to send message to all inactive group members, the following applies. The user subscribes to the group session status, i.e., the conference event package using Group URI (using a SUBSCRIBE request). The status notification (received via a NOTIFY message) contains the Session ID. Then, the user may send a message using Session ID in the way as described above.

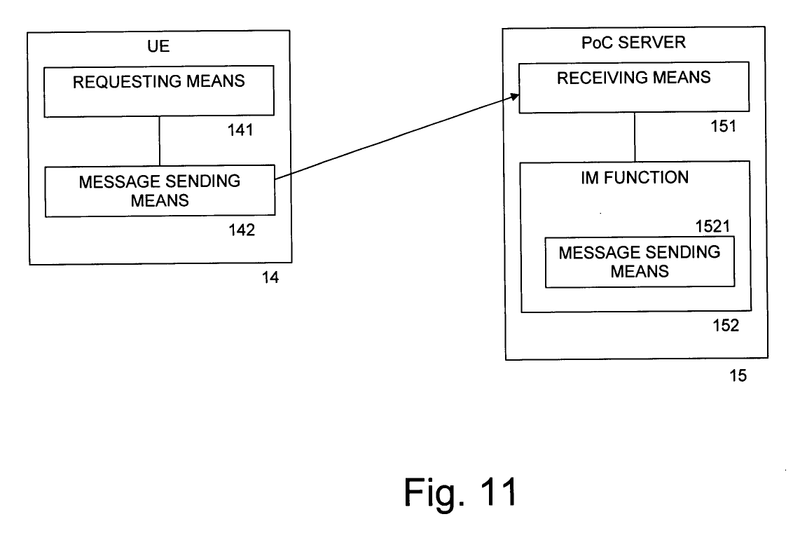

In FIG. 11, a basic structure of the user equipment (terminal device) and the PoC server is shown. The user equipment 14 comprises a requesting means, which creates the request for the second service, i.e., the IM message as described above. This message is sent via the message sending means 142 to the PoC server 15. The PoC server 15 receives the incoming IM message request via a receiving means 151. The PoC server comprises an IM function unit 152 (similar to the PoC servers as described in connection with the first to third embodiments, for example). This IM function unit 152 is adapted to detect all active members of the PoC group in reaction to receiving the message formed using the Session ID. Then, a message sending means 1521 of the IM function unit 152 sends the message to all active members of the PoC group.

Hence, according to the sixth embodiment an easy way of sending messages to active group members is achieved. Namely, according to the present embodiment, OMA PoC 1.0 mechanisms are used, so that the procedure can easily be introduced into standards and no additional signalling is created.

Since the user equipment (terminal) does not need to know the real identities of the recipients, the procedure according to any of the server based embodiments work also in case that some of the group participants have hidden their real identities i.e. anonymous users.

In a following seventh embodiment the use of the Conference State Event Package as described in connection with, e.g., the fifth embodiment is described in more detail. It is however noted that the usage of the Conference State Event Package can also applied to the other embodiments, namely when a user (e.g., user 1 shown in FIG. 1) subscribes to the corresponding conference server (e.g., the PoC/IM server 8 shown in FIG. 1).

As mentioned above, the conference state event package may be used to inform about group membership, for example, to notify which group members are currently not participating in a conference.

According to the present embodiment, information of the non-participating group members are carried in the Conference State Event Package XML structure. Then a user subscribing the Conference State Event Package gets information of all members of the group: both those who are participating in the conference as well as of those who are not participating in the conference.

Traditionally, the Conference State Event Package has carried information only of the users participating in the conference, simply because the conference focus (e.g. application running the conference) normally have no information of those who are not participating in the conference. So, according to the present embodiment, the IETF Conference State Event Package is widened or generalized. The IETF Conference State Event Package is defined, for example, in “A Session Initiation Protocol (SIP) Event Package for Conference State” by J. Rosenberg, H. Schulzrinne and O. Levin, Ed. (Mar. 25, 2005, draft-ietf-sipping-conference-package-10).

In the Conference State Event Package XML structure there is currently no field that directly could carry an “idle” tag or the like attached to those members who are not participants in the conference e.g. PoC Group Session. If the conference focus does not know the list of members of the group, it may retrieve the member list or information of the members of the group from host owning the group or from a database or alike (e.g. from XDM in OMA-POC).

In the following, some options how the information “non-participant”, “inactive”, “idle” or alike could be carried in notification, e.g., in SIP NOTIFY request returned as a response to the subscription e.g. SIP SUBSCRIBE to the Conference State Event Package. These options are described by referring to implementation examples.

In the following, several ways how to carry “non-participant” tag or information in the notifications according to the structure of the Conference State Event Package are described, wherein also the implementation in the XML structure is shown. Therefore, at first the basic elements of the XML structure of the Conference State Event Package are described, as they are also defined in the above-referenced Internet Draft. In particular, those elements as used in the following implementation examples are listed.
<users> and its <user> sub-elements: The <users> element is a container of <user> child elements, each describing a single participant in the conference. There are several attributes defined for <user> element, one of which is “entity”. This attribute contains the URI for the user in the conference. This is a logical identifier, which corresponds to the call signaling authenticated identity of the participant. Another attribute of the <user> element is “state”. This attribute indicates whether the document contains the whole user information (“full”), only the information that has changed since the previous document (“partial”), or the user was removed from the conference (“deleted”).

In the following some child elements are described which are defined for the <user> element:
<display-text>: This element is used to display the user friendly name in the conference.
<roles>: This element MAY contain a set of human readable strings describing the roles of the user in the conference. Note that this information is applicable for human consumption only. This specification doesn't define the set of possible conferencing roles nor the semantics associated with each. It is expected that future conferencing specifications will define these and the corresponding schema extensions, as appropriate.
<endpoint>: By including one or more <endpoint> elements under a parent <user> element, the server can provide the desired level of details (including the state, media streams, and access information) about the user's devices and signaling sessions taking part in the conference.

Several attributes are defined for the <endpoint> element, of which the attribute “entity” is described in the following: The server must generate the ‘entity’ key for each <endpoint> element included under the parent <user>, such as its value is unique in the user context. In SIP terms, this can be the Contact URI, GRUU, etc. Another attribute of the <endpoint> element is “state”. This attribute indicates whether the element contains the whole endpoint information (“full”), only the information that has changed since the previous document (“partial”), or the endpoint has been removed from the conference (“deleted”).

In the following some child elements are described which are defined for the <endpoint> element:
<display-text>: This element contains the display text for the endpoint.
<status>: This element contains the status of the endpoint, and can assume the following values:

connected: The endpoint is a participant in the conference. Depending on the media policies, he/she can send and receive media to and from other participants.

disconnected: The endpoint is not a participant in the conference and no active dialog exists between the endpoint and the focus.

on-hold: Active signaling dialog exists between an endpoint and a focus, but endpoint is “on-hold” for this conference, i.e. he/she is neither “hearing” the conference mix, nor is his/her media being mixed in the conference. As an example, the endpoint has asked to join the conference using SIP, but his/her participation is pending based on moderator approval. In the meantime he/she is hearing music-on-hold or some other kind of related content.

muted-via-focus: Active signaling dialog exists between an endpoint and a focus and the endpoint can “listen” to the conference, but endpoint's media is not being mixed into the conference. Note that sometimes a subset of endpoint media streams can be muted by focus (such as poor quality video) while others (such as voice or IM) can still be active. In this case, it is RECOMMENDED that the “aggregated” endpoint connectivity <status> reflects the status of the most active media.

pending: Endpoint is not yet in the session, but it is anticipated that he/she will join in the near future.

alerting: A PSTN ALERTING or SIP 180 Ringing was returned for the outbound call, endpoint is being alerted.

dialing-in: Endpoint is dialing into the conference, not yet in the roster (probably being authenticated).

dialing-out: Focus has dialed out to connect the endpoint to the conference, but the endpoint is not yet in the roster (probably being authenticated).

disconnecting: Focus is in the process of disconnecting the endpoint (e.g., in SIP a DISCONNECT or BYE was sent to the endpoint).
<joining-method>: This element contains the method by which the endpoint joined the conference.
<joining-info>: This element contains information about how the endpoint joined and may contain the following sub-elements:

when: This element of the XML dateTime type contains the date and time that the endpoint joined the conference and should be expressed in Coordinated Universal Time (UTC).

reason: This element contains the reason the endpoint joined the conference.

by: This element contains the URI of the entity who caused the endpoint to join the conference.
<disconnection-method>: This element contains method by which the endpoint departed the conference.
<disconnection-info>: This element contains information about the endpoint's departure from the conference. In the following, some sub-elements thereof are described:

when: This element of the XML dateTime type contains the date and time that the endpoint departed the conference and should be expressed in Coordinated Universal Time (UTC).

reason: This element contains the reason the endpoint departed the conference.
<call-info>: The <call-info> element provides detailed call signalling information for a call being maintained between the participant and the focus. The <sip> sub-element contains the SIP dialog identifier of the endpoint's dialog with the focus. The element includes sub-elements <display-text>, <call-id>, <to-tag>, <from-tag>.
<media>: This element contains information about a single media stream and is included for each media stream being established between the focus and the <endpoint>.

A single ‘id’ attribute (media id) is defined for this element. This is the media stream identifier being generated by the server such as its value is unique in the endpoint context. This attribute is the key to refer to a particular media stream in the conference document.

In the following, some child elements defined for <media> are described:
<display-text>: This element contains the display text for the media stream.
<type>: This element contains the media type for the media stream.
<label>: The <label> element carries a unique identifier for this stream among all streams in the conference and is assigned by the focus.
<src-id>: The <src-id> element, if applicable, carries the information about the actual source of the media.
<status>: The element <status> indicates the status in both directions of the media stream and has the values “sendrecv”, “sendonly”, “recvonly”, or “inactive”. Note that value specifies the direction from the participant's point of view. For example, a muted participant's stream will have the value of “recvonly”.

It is noted that in the following implementation examples, the end of a definition of field is indicated by adding a backslash (/) before the name of the field, e.g. </roles> marks the end of the definition of this element.

Thus, in the following several options are described how the information “non-participant” could be carried in a notification, e.g., in a NOTIFY request returned as a response to the subscription. It is noted that in the following implementation examples, the additions or amendments with respect to the heretofore know structure of the Conference State Event Package are marked by using italic. Options are illustrated with examples. Note that the examples are not complete and only the essential information from the invention point of view is present in the examples.

In the following it is used as an examples a Sales group with members: Bob, Alice, Mary and John. They use the following URIs:

bob@example.com

alice@example.com

mary@example.com

john@example.commike@example.com

A conference is created and there are Mike and Alice in the conference while Mary and John have not joined the conference, and Bob has left the conference.

The following is an example of a full conference information document:

```
  <?xml version=“1.0” encoding=“UTF-8”?>
  <conference-info
    xmlns=“urn:ietf:params:xml:ns:conference-info”
    entity=“sips:conf233@example.com”
    state=“full” version=“1”>
  <!--
    CONFERENCE INFO
  -->
    <conference-description>
    <subject>Agenda: This month's goals</subject>
      <service-uris>
      <entry>
        <uri>http://sharepoint/salesgroup/</uri>
        <purpose>web-page</purpose>
      </entry>
      </service-uris>
    </conference-description>
  <!--
      CONFERENCE STATE
  -->
    <conference-state>
    <user-count>3</user-count>
    </conference-state>
  <!--
    USERS
  -->
    <users>
    <user entity=“sip:bob@example.com” state=“full”>
      <display-text>Bob Hoskins</display-text>
  <!--
    ENDPOINTS
  -->
      <endpoint entity=“sip:bob@pc33.example.com”>
      <display-text>Bob's Laptop</display-text>
      <status>disconnected</status>
      <disconnection-method>departed</disconnection-method>
      <disconnection-info>
        <when>2005-03-04T20:00:00Z</when>
        <reason>bad voice quality</reason>
        <by>sip:mike@example.com</by>
      </disconnection-info>
  <!--
    MEDIA
  -->
      <media id=“1”>
        <display-text>main audio</display-text>
        <type>audio</type>
        <label>34567</label>
        <src-id>432424</src-id>
        <status>sendrecv</status>
      </media>
  <!--
    CALL INFO
  -->
      <call-info>
        <sip>
        <display-text>full info</display-text>
          <call-id>hsjh8980vhsb78</call-id>
          <from-tag>vav738dvbs</from-tag>
          <to-tag>8954jgjg8432</to-tag>
        </sip>
      </call-info>
      </endpoint>
    </user>
  <!--
    USER
  -->
    <user entity=“sip:alice@example.com” state=“full”>
      <display-text>Alice</display-text>
  <!--
    ENDPOINTS
  -->
      <endpoint
entity=“sip:4j392jsu@example.com;grid=433kj4j3u”>
      <status>connected</status>
      <joining-method>dialed-out</joining-method>
      <joining-info>
        <when>2005-03-04T20:00:00Z</when>
        <by>sip:mike@example.com</by>
      </joining-info>
  <!--
    MEDIA
  -->
      <media id=“1”>
        <display-text>main audio</display-text>
        <type>audio</type>
        <label>34567</label>
        <src-id>534232</src-id>
        <status>sendrecv</status>
      </media>
  <!--
    CALL INFO
  -->
      <call-info>
        <sip>
        <display-text>full info</display-text>
          <call-id>kait4466kumu97</call-id>
          <from-tag>int739dyrt</from-tag>
          <to-tag>7734aiai6868</to-tag>
        </sip>
      </call-info>
      </endpoint>
    </user>
  <!--
    USER
  -->
    <user entity=“sip:mike@example.com” state=“full”>
      <display-text>Mike</display-text>
  <!--
    ENDPOINTS
  -->
      <endpoint
entity=“sip:2243kh19@example.com;grid=277pj8k5d”>
      <status>connected</status>
      <joining-method>dialed-out</joining-method>
      <joining-info>
        <when>2005-03-04T20:00:00Z</when>
      </joining-info>
  <!--
    MEDIA
  -->
      <media id=“1”>
        <display-text>main audio</display-text>
        <type>audio</type>
        <label>34567</label>
        <src-id>229554</src-id>
        <status>sendrecv</status>
      </media>
  <!--
    CALL INFO
  -->
      <call-info>
        <sip>
        <display-text>full info</display-text>
          <call-id>noin8486aito97</call-id>
          <from-tag>kah447pois</from-tag>
          <to-tag>2729jaja4475</to-tag>
        </sip>
      </call-info>
      </endpoint>
    </user>
    </users>
  </conference-info>
```

1) Option 1: NO ROLE: the element <roles> is omitted or empty, so the user has no role in the conference. It sounds logical because the user is not yet participating in the conference.

### EXAMPLE

The Following Child Element is Inserted Inside Each <user> Element:

<roles>
<entry>participant</entry>
</roles>

There may be a role e.g. “ex-participant” for those who have left the conference. Then Bob would get this role. If such role does not exist but “participant” is used also for Bob, the receive needs to parse the received XML data and deduce from the “status” element with the value “disconnected” that Bob is not anymore participating in the conference.

The following <user> elements are inserted inside the <users> element to carry information of the members of the group who haven't joined the conference i.e. the group session:

```
<user entity=“sip:mary@example.com” state=“full”>
  <display-text>Mary</display-text>
</user>
<user entity=“sip:john@example.com” state=“full”>
  <display-text>John</display-text>
</user>
```

After these additions the essential parts of the <users> element look like e.g. the following:

```
<users>
  <user entity=“sip:bob@example.com” state=“full”>
  <display-text>Bob</display-text>
  <roles>
    <entry>participant</entry>
  </roles>
  ...
  </user>
  <user entity=“sip:alice@example.com” state=“full”>
  <display-text>Alice</display-text>
  <roles>
    <entry>participant</entry>
  </roles>
  ...
  </user>
  <user entity=“sip:mike@example.com” state=“full”>
  <display-text>Mike</display-text>
  <roles>
    <entry>participant</entry>
  </roles>
  ...
  </user>
  <user entity=“sip:mary@example.com” state=“full”>
  <display-text>Mary</display-text>
  </user>
  <user entity=“sip:john@example.com” state=“full”>
  <display-text>John</display-text>
  </user>
</users>
```

Alternative empty <roles> element may be used containing empty <entry> child element e.g. empty string or string with space. Then the information of Mary and John would look like the following:

```
</user>
<user entity=“sip:mary@example.com” state=“full”>
  <display-text>Mary</display-text>
  <roles>
  <entry></entry>
  </roles>
</user>
<user entity=“sip:john@example.com” state=“full”>
  <display-text>John</display-text>
  <roles>
  <entry> </entry>
  </roles>
</user>
```

Or another alternative may be the following:

```
</user>
<user entity=“sip:mary@example.com” state=“full”>
  <display-text>Mary</display-text>
  <roles></roles>
</user>
<user entity=“sip:john@example.com” state=“full”>
  <display-text>John</display-text>
  <roles> </roles>
</user>
```

2) Option 2: NEW ROLE: A new <entry> type string in “user-roles-type” of <roles> e.g. “non-participant”, “idle” or similar or alike may be used that means that the user is not yet invited to the conference.

In this case, the essential parts of <users> element of the xml structure of the amended Conference State Event Package would be in the following form for example:

```
<users>
  <user entity=“sip:bob@example.com” state=“full”>
  <display-text>Bob</display-text>
  <roles>
    <entry>participant</entry>
  </roles>
  ...
  </user>
  <user entity=“sip:alice@example.com” state=“full”>
  <display-text>Alice</display-text>
  <roles>
    <entry>participant</entry>
  </roles>
  ...
  </user>
  <user entity=“sip:mike@example.com” state=“full”>
  <display-text>Mike</display-text>
  <roles>
    <entry>participant</entry>
  </roles>
  ...
  </user>
  <user entity=“sip:mary@example.com” state=“full”>
  <display-text>Mary</display-text>
  <roles>
    <entry>non-participant</entry>
  </roles>
  </user>
  <user entity=“sip:john@example.com” state=“full”>
  <display-text>John</display-text>
  <roles>
    <entry>non-participant</entry>
  </roles>
  </user>
</users>
```

3) Option 3: NEW DISCONNECTION-INFO REASON: <status> child element of the <endpoint> element contains “disconnected” and the <reason> in “execution-type” of the <disconnection-info> says e.g. “idle”, “non-participant” or something similar or alike. <when> is omitted or is empty, zero or other suitable time. <by> is empty or omitted. The <disconnection-method> is omitted or empty. (In case it cannot be omitted nor empty for some reason, the most suitable value seems to be “booted”). <joining-info> and <joining-method> are omitted.

### EXAMPLE

The essential parts of the <users> element look like the following:

```
<users>
  <user entity=“sip:bob@example.com” state=“full”>
  <display-text>Bob</display-text>
  <endpoint entity=“sip:bob@pc33.example.com”>
    <display-text>Bob's Laptop</display-text>
    <status>disconnected</status>
    <disconnection-method>departed</disconnection-method>
    <disconnection-info>
    <when>2005-03-04T20:00:00Z</when>
    <reason>bad voice quality</reason>
    <by>sip:mike@example.com</by>
    </disconnection-info>
  ...
  </endpoint>
  </user>
  <user entity=“sip:alice@example.com” state=“full”>
  <display-text>Alice</display-text>
  <endpoint entity=“sip:4j392jsu@example.com;grid=433kj4j3u”>
    <status>connected</status>
    ...
  </endpoint>
  </user>
  <user entity=“sip:mike@example.com” state=“full”>
  <display-text>Mike</display-text>
  <endpoint entity=“sip:2243kh19@example.com;grid=277pj8k5d”>
    <status>connected</status>
  ...
  </endpoint>
  </user>
  <user entity=“sip:mary@example.com” state=“full”>
  <display-text>Mary</display-text>
  <endpoint entity=“”>
    <status>disconnected</status>
    <disconnection-info>
    <reason>non-participant</reason>
    </disconnection-info>
  </endpoint>
  </user>
  <user entity=“sip:john@example.com” state=“full”>
  <display-text>John</display-text>
  <endpoint entity=“”>
    <status>disconnected</status>
    <disconnection-info>
    <reason>non-participant</reason>
    </disconnection-info>
  </endpoint>
  </user>
</users>
```

4) Option 4: NEW JOINING-INFO REASON: <status> child element of the <endpoint> element contains “disconnected” and the <reason> in “execution-type” of the <joining-info> says e.g. “idle”, “non-participant” or something similar or alike. <when> is omitted or is empty, zero or other suitable time. <by> is empty or omitted. The <joining-method> is omitted or empty.

### EXAMPLE

The essential parts of the <users> element look like e.g. the following:

```
<users>
  <user entity=“sip:bob@example.com” state=“full”>
  <display-text>Bob</display-text>
  <endpoint entity=“sip:bob@pc33.example.com”>
    <display-text>Bob's Laptop</display-text>
    <status>disconnected</status>
    <disconnection-method>departed</disconnection-method>
    <disconnection-info>
    <when>2005-03-04T20:00:00Z</when>
    <reason>bad voice quality</reason>
    <by>sip:mike@example.com</by>
    </disconnection-info>
  ...
  </endpoint>
  </user>
  <user entity=“sip:alice@example.com” state=“full”>
  <display-text>Alice</display-text>
  <endpoint entity=“sip:4j392jsu@example.com;grid=433kj4j3u”>
    <status>connected</status>
    ...
  </endpoint>
  </user>
  <user entity=“sip:mike@example.com” state=“full”>
  <display-text>Mike</display-text>
  <endpoint entity=“sip:2243kh19@example.com;grid=277pj8k5d”>
    <status>connected</status>
  ...
  </endpoint>
  </user>
  <user entity=“sip:mary@example.com” state=“full”>
  <display-text>Mary</display-text>
  <endpoint entity=“”>
    <status>disconnected</status>
    <joining-info>
    <reason>non-participant</reason>
    </joining-info>
  </endpoint>
  </user>
  <user entity=“sip:john@example.com” state=“full”>
  <display-text>John</display-text>
  <endpoint entity=“”>
    <status>disconnected</status>
    <joining-info>
    <reason>non-participant</reason>
    </joining-info>
  </endpoint>
  </user>
</users>
```

5) Option 5: Combination of both the option 3 and 4. That is, the elements <joining-info> and <disconnection-info> are included.
6) Option 6: <call-info> is empty or missing.

In the example the essential parts of the <users> element would look like e.g. the following:

```
  <users>
  <user entity=“sip:bob@example.com” state=“full”>
    <display-text>Bob Hoskins</display-text>
<!--
  ENDPOINTS
-->
    <endpoint entity=“sip:bob@pc33.example.com”>
    <display-text>Bob's Laptop</display-text>
    <status>disconnected</status>
    <disconnection-method>departed</disconnection-method>
    <disconnection-info>
      <when>2005-03-04T20:00:00Z</when>
      <reason>bad voice quality</reason>
      <by>sip:mike@example.com</by>
    </disconnection-info>
<!--
  MEDIA
-->
    <media id=“1”>
      <display-text>main audio</display-text>
      <type>audio</type>
      <label>34567</label>
      <src-id>432424</src-id>
      <status>sendrecv</status>
    </media>
<!--
  CALL INFO
-->
    <call-info>
      <sip>
      <display-text>full info</display-text>
        <call-id>hsjh8980vhsb78</call-id>
        <from-tag>vav738dvbs</from-tag>
        <to-tag>8954jgjg8432</to-tag>
      </sip>
    </call-info>
    </endpoint>
  </user>
<!--
  USER
-->
  <user entity=“sip:alice@example.com” state=“full”>
    <display-text>Alice</display-text>
<!--
  ENDPOINTS
-->
    <endpoint entity=“sip:4j392jsu@example.com;grid=433kj4j3u”>
    <status>connected</status>
    <joining-method>dialed-out</joining-method>
    <joining-info>
      <when>2005-03-04T20:00:00Z</when>
      <by>sip:mike@example.com</by>
    </joining-info>
<!--
  MEDIA
-->
    <media id=“1”>
      <display-text>main audio</display-text>
      <type>audio</type>
      <label>34567</label>
      <src-id>534232</src-id>
      <status>sendrecv</status>
    </media>
<!--
  CALL INFO
-->
    <call-info>
      <sip>
      <display-text>full info</display-text>
        <call-id>kait4466kumu97</call-id>
        <from-tag>int739dyrt</from-tag>
        <to-tag>7734aiai6868</to-tag>
      </sip>
    </call-info>
    </endpoint>
  </user>
<!--
  USER
-->
  <user entity=“sip:mike@example.com” state=“full”>
    <display-text>Mike</display-text>
<!--
  ENDPOINTS
-->
    <endpoint entity=“sip:2243kh19@example.com;grid=277pj8k5d”>
    <status>connected</status>
    <joining-method>dialed-out</joining-method>
    <joining-info>
      <when>2005-03-04T20:00:00Z</when>
    </joining-info>
<!--
  MEDIA
-->
    <media id=“1”>
      <display-text>main audio</display-text>
      <type>audio</type>
      <label>34567</label>
      <src-id>229554</src-id>
      <status>sendrecv</status>
    </media>
<!--
  CALL INFO
-->
    <call-info>
      <sip>
      <display-text>full info</display-text>
        <call-id>noin8486aito97</call-id>
        <from-tag>kah447pois</from-tag>
        <to-tag>2729jaja4475</to-tag>
      </sip>
    </call-info>
    </endpoint>
  </user>
  <user entity=“sip:mary@example.com” state=“full”>
    <display-text>Mary</display-text>
    <endpoint entity=“”>
    <call-info>
    </call-info>
    </endpoint>
  </user>
  <user entity=“sip:john@example.com” state=“full”>
    <display-text>John</display-text>
    <endpoint entity=“”>
    <call-info>
    </call-info>
    </endpoint>
  </user>
  </users>
```

7) Option 7: <media> is empty or missing.

In the example the essential parts of the <users> element would look like e.g. the following:

```
  <users>
    <user entity=“sip:bob@example.com” state=“full”>
      <display-text>Bob Hoskins</display-text>
<!--
    ENDPOINTS
-->
      <endpoint entity=“sip:bob@pc33.example.com”>
        <display-text>Bob's Laptop</display-text>
        <status>disconnected</status>
        <disconnection-method>departed</disconnection-method>
        <disconnection-info>
          <when>2005-03-04T20:00:00Z</when>
          <reason>bad voice quality</reason>
          <by>sip:mike@example.com</by>
        </disconnection-info>
<!--
    MEDIA
-->
        <media id=“1”>
          <display-text>main audio</display-text>
          <type>audio</type>
          <label>34567</label>
          <src-id>432424</src-id>
          <status>sendrecv</status>
        </media>
<!--
    CALL INFO
-->
        <call-info>
          <sip>
            <display-text>full info</display-text>
              <call-id>hsjh8980vhsb78</call-id>
              <from-tag>vav738dvbs</from-tag>
              <to-tag>8954jgjg8432</to-tag>
          </sip>
        </call-info>
      </endpoint>
    </user>
<!--
    USER
-->
    <user entity=“sip:alice@example.com” state=“full”>
      <display-text>Alice</display-text>
<!--
    ENDPOINTS
-->
      <endpoint entity=“sip:4j392jsu@example.com;grid=433kj4j3u”>
        <status>connected</status>
        <joining-method>dialed-out</joining-method>
        <joining-info>
          <when>2005-03-04T20:00:00Z</when>
          <by>sip:mike@example.com</by>
        </joining-info>
<!--
    MEDIA
-->
        <media id=“1”>
          <display-text>main audio</display-text>
          <type>audio</type>
          <label>34567</label>
          <src-id>534232</src-id>
          <status>sendrecv</status>
        </media>
<!--
    CALL INFO
-->
        <call-info>
          <sip>
            <display-text>full info</display-text>
              <call-id>kait4466kumu97</call-id>
              <from-tag>int739dyrt</from-tag>
              <to-tag>7734aiai6868</to-tag>
          </sip>
        </call-info>
      </endpoint>
    </user>
<!--
    USER
-->
    <user entity=“sip:mike@example.com” state=“full”>
      <display-text>Mike</display-text>
<!--
    ENDPOINTS
-->
      <endpoint entity=“sip:2243kh19@example.com;grid=277pj8k5d”>
        <status>connected</status>
        <joining-method>dialed-out</joining-method>
        <joining-info>
          <when>2005-03-04T20:00:00Z</when>
        </joining-info>
<!--
    MEDIA
-->
        <media id=“1”>
          <display-text>main audio</display-text>
          <type>audio</type>
          <label>34567</label>
          <src-id>229554</src-id>
          <status>sendrecv</status>
        </media>
<!--
    CALL INFO
-->
        <call-info>
          <sip>
            <display-text>full info</display-text>
              <call-id>noin8486aito97</call-id>
              <from-tag>kah447pois</from-tag>
              <to-tag>2729jaja4475</to-tag>
          </sip>
        </call-info>
      </endpoint>
    </user>
    <user entity=“sip:mary@example.com” state=“full”>
      <display-text>Mary</display-text>
      <endpoint entity=“”>
        <media id=“1”>
        </media>
      </endpoint>
    </user>
    <user entity=“sip:john@example.com” state=“full”>
      <display-text>John</display-text>
      <endpoint entity=“”>
        <media id=“1”>
      </media>
    </endpoint>
  </user>
</users>
```

8) Option 8: A new endpoint-status-type value.

A new value is added to the endpoint-status-type type. The new value may be called for example “not-joined”, “non-participant”, “inactive”, “idle” or alike.

The essential parts of the <users> element look like e.g. the following:

```
<users>
  <user entity=“sip:bob@example.com” state=“full”>
    <display-text>Bob</display-text>
    <endpoint entity=“sip:bob@pc33.example.com”>
      <display-text>Bob's Laptop</display-text>
      <status>disconnected</status>
    ...
    </endpoint>
  </user>
  <user entity=“sip:alice@example.com” state=“full”>
    <display-text>Alice</display-text>
    <endpoint entity=“sip:4j392jsu@example.com;grid=433kj4j3u”>
      <status>connected</status>
      ...
    </endpoint>
  </user>
  <user entity=“sip:mike@example.com” state=“full”>
    <display-text>Mike</display-text>
    <endpoint entity=“sip:2243kh19@example.com;grid=277pj8k5d”>
      <status>connected</status>
    ...
    </endpoint>
  </user>
  <user entity=“sip:mary@example.com” state=“full”>
    <display-text>Mary</display-text>
    <endpoint entity=“”>
      <status>not-joined</status>
    </endpoint>
  </user>
  <user entity=“sip:john@example.com” state=“full”>
    <display-text>John</display-text>
    <endpoint entity=“”>
      <status>not-joined</status>
    </endpoint>
  </user>
</users>
```

9) Option 9: A new element is added.

A new element e.g. <member-status> is added with suitable values e.g. “in-conference” and “not-in-conference” or “active” and “inactive” or alike as a new child element to <user> element or to any other suitable element or child element.

The essential parts of the <users> element look like e.g. the following:

```
<users>
  <user entity=“sip:bob@example.com” state=“full”>
    <display-text>Bob</display-text>
    <member-status>active</member-status>
    <endpoint entity=“sip:bob@pc33.example.com”>
      <display-text>Bob's Laptop</display-text>
      <status>disconnected</status>
    ...
    </endpoint>
  </user>
  <user entity=“sip:alice@example.com” state=“full”>
    <display-text>Alice</display-text>
    <member-status>active</member-status>
    <endpoint entity=“sip:4j392jsu@example.com;grid=433kj4j3u”>
      <status>connected</status>
      ...
    </endpoint>
  </user>
  <user entity=“sip:mike@example.com” state=“full”>
    <display-text>Mike</display-text>
    <member-status>active</member-status>
    <endpoint entity=“sip:2243kh19@example.com;grid=277pj8k5d”>
      <status>connected</status>
    ...
    </endpoint>
  </user>
  <user entity=“sip:mary@example.com” state=“full”>
    <display-text>Mary</display-text>
    <member-status>inactive</member-status>
  </user>
  <user entity=“sip:john@example.com” state=“full”>
    <display-text>John</display-text>
    <member-status>inactive</member-status>
  </user>
</users>
```

Options can be combined.

In the XML structure, many elements have an attribute ‘minOccurs=“0”’ evidently because the same structure is used in the initial notification when the full state is carried, as well as in notifications carrying only the changed parts. This makes it possible to omit an element as an indication of “non-participant”. That is, for example, the “roles” element may be omitted or it may be empty or contain only space or empty string and thus the option 1 can be implemented. In this way, options 1, 6 and 7 can be implemented.

Thus, according to the present seventh embodiment, a simple and easy way to get a list of the non-participating members in the conference e.g. PoC Group Session is provided. Namely, changes of some options are simple and allowed according to the XML structure, so that only amendments within the existing standards are necessary.

Furthermore, the host of the conference, i.e., the focus has the list of members of the group if it has setup the group session (e.g. Pre-arranged PoC Group Session in OMA-POC). If it hasn't the list, it may retrieve the member list from a database or alike e.g. XDM server/host/service in OMA-POC.

The invention is not limited to the embodiments described above, and various modifications are possible.

For example, in the above embodiments, the subgroups were created based on active/non-active members. However, the subgroups can be formed based on other distinguishing features, for example type of the user equipment (mobile/non-mobile), age of the users, sex and the like. Subgroups can be formed based on more than one distinguishing features e.g. location, age and sex.

For example, with respect to the seventh embodiment, the element “roles” in the Conference State Event Package structure could be correspondingly amended e.g. with new child element(s), or new child element(s) could be introduced to the element “user”, in order to indicate the corresponding distinguishing features.

To carry the information of sex could be implemented e.g. by the following way:

```
<user entity=“sip:mary@example.com” state=“full”>
  <display-text>Mary</display-text>
  <member-status>
    <status>active</status>
    <sex>female</sex>
    <region>Helsinki</region>
    <age>40-50</age>
    <hobby>
      <entry>movies</entry>
      <entry>theater</entry>
  </member-status>
</user>
```

The person skilled in the art can easily write the required additional XML schema lines.

Receiving notification containing such information gives the receiver a possibility to send e.g. a message only to those persons of the opposite sex that are living in the same region as the receiver and are interested in movies.

SIP (Session Initiation Protocol) is used in the examples of the embodiments. However the invention is not limited to SIP. The invention can be applied to whatever protocol.

Moreover, in the above description the term “Conference State Event Package” has been used. However, this is only an example for conference related information, and also other forms for the conference related information may be used. It is noted, that, with respect to the term “Conference State Event Package” actually the name of the event package is “conference” that is used in the Event header.

Moreover, PoC and IM are only examples for the first and second services. Any service can be used, as long as at least in the first service the user can have different states. For example, in a game session, the participants of the gaming group who have already finished playing or received “game over” (in other words, being “inactive”) may want to establish a chat session or a conference call to discuss the game. In a similar manner, active members of a chat group may establish a conference call or PoC session.

Another example for a first service is a conference service, and another example for a second service is a video stream. In this case, the “state” mentioned above can be whether a user of the conference service is able to receive a video stream or not, for example.

In particular, all that has been described in connection with IM in the above embodiments can be applied to whichever service. According to the embodiments of the invention, groups (independently how they are defined) are utilized and means or measures are provided to address subgroups, i.e., part of the members of the group e.g. members participating in the session, members from the same company, members living on the same location (city, street, country, etc), members with the same profession, member of the same age and so on. The server establishing the second service may collect the information from several servers in the network, for example, from a presence server, and establish the second service only to those users matching the criteria. In the embodiments members participating in the session (i.e. active members) and members not participating in the session (i.e. inactive members) are used as examples of the many possible subgroups.

Furthermore, the embodiments can be freely combined. For example, in the sixth embodiment a combined PoC/IM server is used as the group hosting PoC server. However, also separated PoC and IM servers may be applied, similar as described in connection with the fourth or fifth embodiment or the modifications of the first to fifth embodiments.

Hence, according to the present invention, the user experience when using PoC voice and text messaging is improved. The invention enables an easy way to send text messages to PoC voice session participants or whole group members without the need to define manually the recipient lists. Additionally Enhanced Participant Information data can be used to derive the inactive member list, which can be utilised e.g. as a target group for a reminder message of the ongoing PoC session.

Furthermore, it should be noted that the user equipment (UE) or the terminal device according to the invention may for example be any device by means of which a user may access a communication network; this implies mobile as well as non-mobile devices and networks, independent of the technology platform on which they are based.

Moreover, method steps likely to be implemented as software code portions and being run using a processor at one of the server/client entities are software code independent and can be specified using any known or future developed programming language. Method steps and/or devices/means likely to be implemented as hardware components are hardware independent and can be implemented using any known or future developed hardware technology or any hybrids of these, such as MOS, CMOS, BiCMOS, ECL, TTL, etc, using for example ASIC components or DSP components, as an example.

Generally, any method step is suitable to be implemented as software or by hardware without changing the idea of the present invention.

Devices can be implemented as individual devices, but this does not exclude that they are implemented in a distributed fashion throughout the system, as long as the functionality of the device is preserved. Devices can be implemented also as combined devices.

1. A method of providing services to a group of users, wherein
the group of users is assigned to a first service, the group being identified by a group identity,
each of the users assigned to the first service may have different states regarding the first service, the method comprising the steps of:
receiving a request for establishing a second service to users assigned to the first service, said request comprising the group identity and an indication of a state regarding the first service; and
providing the second service to the users having the indicated state in the first service.

2. The method according to claim 1, wherein said step of receiving comprises receiving a request comprising said indication of the state which comprises one of a prefix in a group identity, a header in the request, a tag in the request, and a parameter in the request

3. The method according to claim 1, further comprising:
providing at least one subgroup based on the state of the users of the group and forming a subgroup identity for the at least one subgroup, wherein said indication of the state regarding the first service is part of said subgroup identity; and
sending the subgroup identity to at least one of the users.

4. The method according to claim 1, further comprising the step of:
accessing a network administration element for retrieving a list of group members.

5. The method according to claim 1, wherein the request is received at a network element providing the first service and the second service, and the step of receiving a request for the second service comprises the steps of:
detecting the state of the users of the group identity regarding the first service; and
establishing the second service to the users depending on the state of the users.

6. The method according to claim 1, wherein the request is received at a network element providing the second service, and the step of receiving a request for the second service comprises the steps of:
accessing a network element providing the first service and detecting the state of the users; and
establishing the second service to the users depending on the state of the users.

7. The method according to claim 1, wherein the first and the second services comprise one of Push-to-talk over Cellular (PoC), Instant Messaging (IM), game service, chat service, conference service, video streaming, and application sharing.

8. The method according to claim 1, wherein, in the step of receiving a request for the second service, a Session Initiation Protocol MESSAGE request is sent.

9. A network control element, the network element being part of a system where a group of users is assigned to a first service, the group being identified by a group identity, and each of the users assigned to the first service may have different states regarding the first service, the network control element comprising:
means for receiving a request for providing a second service to users of the group, the request comprising an identity of the group and an indication of a state of the users regarding the first service;
means for discovering members of the group;
means for discovering the states of the members regarding the first service; and
means for processing the request for providing the second service to the members of the group, the discovered states of the members matching the indication of the state.

10. The network control element according to claim 9, wherein the network control element hosts the first service and/or provides the second service.

11. The network control element according to claim 9, wherein the means for discovering members of the group is configured to request a member list from one of a server providing the first service and a network administration element.

12. The network control element according to claim 9, wherein the means for discovering states of the members is configured to request the states from one of a server providing the first service, a network administration element, and a presence server.

13. The network control element according to claim 9, wherein the means for processing the request for the second service is configured to forward the request for providing the second service to a server providing the second service.

14. The network control element according to claim 9, wherein the means for processing the request for the second service is configured to provide/host the second service.

15. The network control element according to claim 9, comprising:
means for providing at least one subgroup based on the state of the users of the group and forming a subgroup identity for the at least one subgroup, wherein said indication of the state regarding the first service is part of said subgroup identity; and
sending means for sending the subgroup identity to at least one of the users.

16. The network control element according to claim 15, wherein the subgroup identity is formed based on the group identity by adding one of a prefix, a suffix, and a parameter indicating the subgroup.

17. A terminal device configured to be used for a first service, to which a group of users is assigned, the group being identified by a group identity, each of the users assigned to the first service may have different states regarding the first service,
the terminal device comprising:
a first requesting means for requesting the users assigned to the group identity, and requesting information on the users,of the group currently participating in the first service;
determining means for determining states of the users of the group regarding the first service based on the requested information; and
a second requesting means for requesting a second service for users selected depending on the state of the users regarding the first service.

18. The terminal device according to claim 17, wherein the first requesting means is configured to request the information from at least one of a server hosting the first service and a network administration element.

19. The terminal device according to claim 18, wherein the first requesting means is configured to request the users assigned to the group identity from the network administration element and to request the information on the users of the group currently participating in the first service from the server hosting the first service.

20. The terminal device according to claim 17, wherein the first requesting means is configured to send an request to subscribe to a conference.

21. The terminal device according to claim 20, wherein said determining means is configured to determine said states of the users of the group regarding the first service based on conference related information received in a message issued in response to the subscribe request, the conference related information comprising an indication of the state of the users.

22. The terminal device according to claim 21, wherein the indication in the conference related information comprises one of a presence of an information element and an absence of an information element in the structure of the conference related information.

23. A method of providing services to a group of users, wherein
the group of users is assigned to a first service, the group being identified by a group identity,
each of the users assigned to the first service may be active or inactive with respect to the first service, wherein a session identity is assigned to the users being active in the first service, the method comprising the steps of:
receiving a request for establishing a second service to users assigned to the first service based on the session identity; and
providing the second service to the users being active with respect to the first service.

24. The method according to claim 23, wherein the receiving step comprises the step of:
receiving a routable address created based on the session identity and an indication of an active state.

25. A method of providing services to a group of users, wherein
the group of users is assigned to a first service, the group being identified by a group identity,
each of the users assigned to the first service may be active or inactive with respect to the first service, wherein a session identity is assigned to the users being active in the first service, the method comprising the steps of:
receiving a request for establishing a second service to users not assigned to the first service based on the session identity;
deriving the users being inactive based on the session identity; and
providing the second service to the users being inactive with respect to the first service.

26. The method according to claim 25, wherein the deriving step comprises:
comparing a list of all group members with a list of group members currently assigned with the session identity; and
extracting those users from the list of all group members which are currently not assigned with the session identity.

27. The method according to claim 25, wherein the step of receiving the request comprises receiving a routable address created based on the session identity and a parameter indicating an inactive state.

28. The method according to claim 23 or 25, further comprising the step of:
accessing a network administration element for retrieving a list of group members.

29. The method according to claim 23 or 25, further comprising the step of:
sending a SUBSCRIBE message to a network control element hosting the first service; and
receiving a status notification including the session identity in response to the SUBSCRIBE message.

30. The method according to claim 23 or 25, wherein the first and the second services comprise one of Push-to-talk over Cellular (PoC), Instant Messaging (IM), game service, chat service, conference service, video streaming, and application sharing.

31. A terminal device configured to be used for a first service, to which a group of users is assigned, the group being identified by a group identity, each of the users assigned to the first service may be active or inactive with respect to the first service, and a session identity is assigned to the users being active in the first service, the terminal device comprising:
requesting means for creating a request for a second service, wherein, when the second service is to be established to active users assigned to the first service, the request is created based on the session identity; and
sending means for sending the request for the second service to a network control element hosting at least one of the first service and the second service.

32. The terminal device according to claim 31, wherein the requesting means is configured to create a routable address based on the session identity, and to send a service request message to a network control element hosting the first service.

33. The terminal device according to claim 31, further comprising:
a session identity detecting means for sending a SUBSCRIBE message to a network control element hosting the first service, and for receiving a status notification including the session identity in response to the SUBSCRIBE message.

34. The terminal device according to claim 31, wherein the first and the second services comprise one of Push-to-talk over Cellular (PoC), Instant Messaging (IM), game service, chat service, conference service, video streaming, and application sharing.

35. A network control element for hosting a first service for a group of users, wherein the group of users is assigned to the first service, the group being identified by a group identity, each of the users assigned to the first service may be active or inactive with respect to the first service, and a session identity is assigned to the users being active in the first service, the network control element comprising:
receiving means for receiving a request for establishing a second service to the users assigned to the first service based on the session identity; and
service providing means for providing the second service to the users being active with respect to the first service.

36. The network control element according to claim 35, wherein the service providing means is configured to provide the requested service based on a routable address which is created based on the session identity.

37. The network control element according to claim 35, further comprising:
accessing means for accessing a network administration element for retrieving a list of group members.

38. The network control element according to claim 35, further comprising:
subscription means for receiving a SUBSCRIBE message from a user equipment and for sending a status notification including the session identity in response to the SUBSCRIBE message.

39. The network control element according to claim 35, wherein the first and the second services comprise one of Push-to-talk over Cellular (PoC), Instant Messaging (IM), game service, chat service, conference service, video streaming, and application sharing.

40. A computer program product for a computer, the computer program product comprising processor implementable instructions, wherein, when the computer program product is run on the computer, the following steps are performed:
receiving a request for establishing a second service to users assigned to a first service, said request comprising a group identity and an indication of a state regarding the first service; and
providing the second service to the users having the indicated state in the first service.

41. The computer program product according to claim 40, wherein the computer program product comprises a computer-readable medium on which the software code portions are stored.

42. The computer program product according to claim 40, wherein the computer program product is directly loadable into an internal memory of the computer.

43. The computer program product according to claim 40, wherein the computer is a processing device of a network control element hosting at least one of the first service and the second service.

44. A terminal device configured to be used for a first service, to which a group of users is assigned, the group being identified by a group identity,
the terminal device comprising:
detecting means for detecting that a second service is to be requested to users assigned to the first service having a predetermined state regarding the first service; and
requesting means for creating a request for providing the second service, wherein the request comprises the group identity of the first service and an indication of said predetermined state regarding the first service, and for sending the request to a server providing at least one of the first service and the second service.

45. A terminal device according to claim 44, further comprising:
input means for allowing a user of the terminal device to determine said predetermined state regarding the first service.

46. A network system comprising:
a network control element comprising
means for receiving a request for providing a second service to users of a group, the request comprising an identity of the group and an indication of a state of the users regarding a first service,
means for discovering members of the group,
means for discovering the states of the members regarding the first service, and
means for processing the request for providing the second service to the members of the group, the discovered states of the members matching the indication of the state; and
a terminal device comrpising
a first requesting means for requesting the users assigned to the group identity, and requesting information on the users of the group currently participating in the first service,
determining means for determining states of the users of the group regarding the first service based on the requested information, and
a second requesting means for requesting a second service for users selected depending on the state of the users regarding the first service.

47. A network system comprising:
a terminal device comprising
requesting means for creating a request for a second service, wherein, when the second service is to be established to active users assigned to a first service, the request is created based on a session identity, and
sending means for sending the request for the second service to a network control element hosting at least one of the first service and the second service; and
a network control element comprising
receiving means for receiving a request for establishing a second service to the users assigned to the first service based on the session identity; and
service providing means for providing the second service to the users being active with respect to the first service.
